(19) United States
(12) Patent Application Publication
(10) Pub. No.: US 2025/0347866 A1
(43) Pub. Date: Nov. 13, 2025

(54) OPTICAL DEVICE AND METHOD OF MANUFACTURE

(71) Applicant: Taiwan Semiconductor Manufacturing Co., Ltd., Hsinchu (TW)

(72) Inventors: Ming-Fa Chen, Taichung City (TW); Chih-Tsung Tsai, Tainan City (TW); Kuo-Chin Hsu, Taichung City (TW)

(21) Appl. No.: 19/275,785

(22) Filed: Jul. 21, 2025

Related U.S. Application Data
(63) Continuation of application No. 18/526,920, filed on Dec. 1, 2023.
(60) Provisional application No. 63/517,397, filed on Aug. 3, 2023.

(51) Int. Cl. G02B 6/42

(52) U.S. Cl. CPC G02B 6/4214

(57) ABSTRACT

Optical devices and methods of manufacture are presented in which a mirror structure is utilized with an optical interposer. In embodiments a method patterns a substrate to form a recess with a sidewall, forms a mirror coating on the sidewall, deposits and patterns a material to form a first waveguide adjacent to the mirror coating, and bonds an optical interposer over the first waveguide.

### PRIORITY CLAIM AND CROSS-REFERENCE

This application is a continuation of U.S. patent application Ser. No. 18/526,920, filed on Dec. 1, 2023, which application claims the benefit of U.S. Provisional Application No. 63/517,397, filed on Aug. 3, 2023, which applications are hereby incorporated herein by reference.

### BACKGROUND

Electrical signaling and processing is one technique for signal transmission and processing. Optical signaling and processing have been used in increasingly more applications in recent years, particularly due to the use of optical fiber-related applications for signal transmission.

Optical signaling and processing are typically combined with electrical signaling and processing to provide full-fledged applications. For example, optical fibers may be used for long-range signal transmission, and electrical signals may be used for short-range signal transmission as well as processing and controlling. Accordingly, devices integrating long-range optical components and short-range electrical components are formed for the conversion between optical signals and electrical signals, as well as the processing of optical signals and electrical signals. Packages thus may include both optical (photonic) dies including optical devices and electronic dies including electronic devices.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1-9 illustrate formation of a first optical package, in accordance with some embodiments.

FIG. 10 illustrates a patterning of a support substrate, in accordance with some embodiments.

FIG. 11 illustrates formation of a mirror coating, in accordance with some embodiments.

FIG. 12 illustrates formation of an active layer of optical components, in accordance with some embodiments.

FIG. 13 illustrates a bonding of the first optical package to the support substrate, in accordance with some embodiments.

FIG. 14 illustrates a thinning of the support substrate, in accordance with some embodiments.

FIG. 15 illustrates formation of external connectors, in accordance with some embodiments.

FIGS. 16A-16B illustrates bonding of the support substrate to other substrates, in accordance with some embodiments.

FIG. 17 illustrates a patterning of a second support substrate, in accordance with some embodiments.

FIG. 18 illustrates forming a mirror coating on the second support substrate, in accordance with some embodiments.

FIG. 19 illustrates an optical package with a through via, in accordance with some embodiments.

FIG. 20 illustrates a thinning of a substrate of the optical package, in accordance with some embodiments.

FIG. 21 illustrates a bonding of the optical package to the second support substrate, in accordance with some embodiments.

FIG. 22 illustrates deposition of a gap-fill, in accordance with some embodiments.

FIG. 23 illustrates an attachment of a support structure, in accordance with some embodiments.

FIG. 24 illustrates a removal of a portion of the second support structure, in accordance with some embodiments.

FIGS. 25-26 illustrate another orientation using the second support substrate, in accordance with some embodiments.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Embodiments will now be discussed with respect to certain embodiments in which a support substrate with a mirror coating is utilized to reflect light into and out of a waveguide related to an optical interposer, thereby combining a metal reflector with a compact universal photonic engine (COUPE) structure to form a single silicon photonics die using a 7 nm process node or smaller. Using the reflection the optical interposer may utilize an edge coupler instead of a grating coupler, allowing for better transfer of signals. The embodiments presented, however, are intended to be illustrative and is not intended to limit the ideas presented to the precise embodiments described. Rather, the ideas presented may be incorporated into a wide variety of embodiments, and all such embodiments may be included within the overall scope of the disclosure.

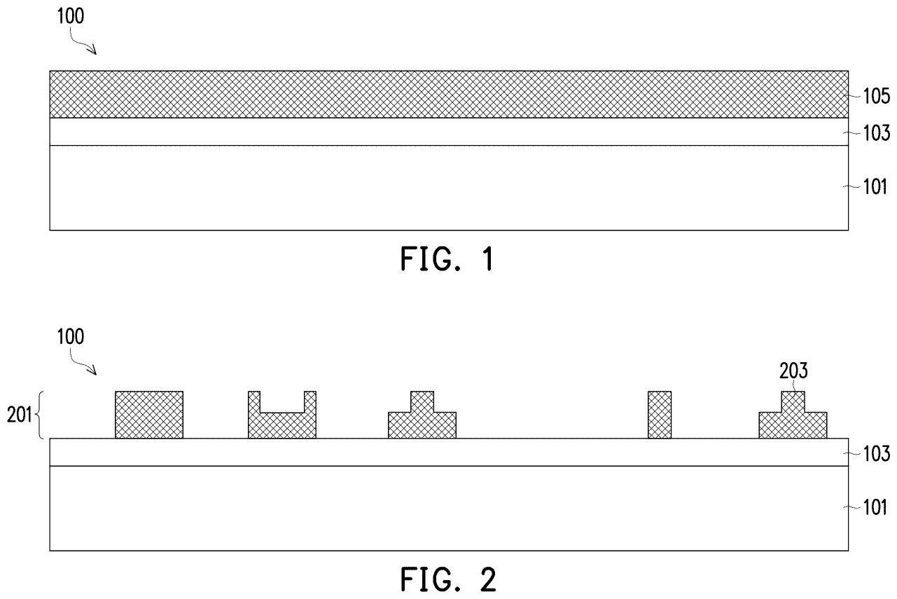

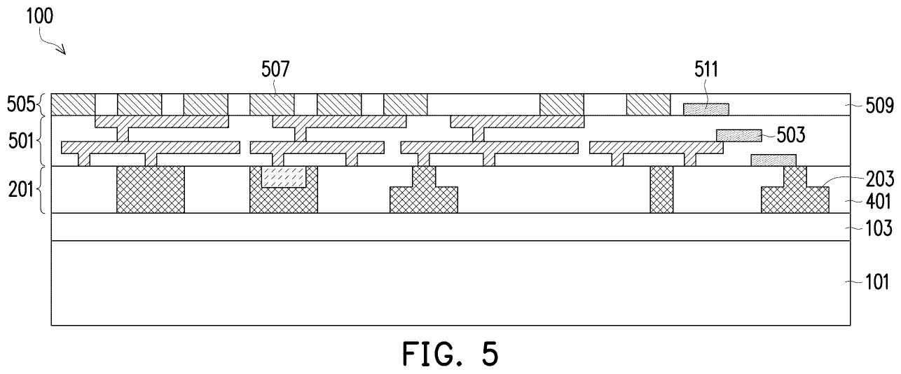

With reference now to FIG. 1, there is illustrated an initial structure of an optical interposer 100 (seen in FIG. 5), in accordance with some embodiments. In the particular embodiment illustrated in FIG. 1, the optical interposer 100 is a photonic integrated circuit (PIC) and comprises at this stage a first substrate 101, a first insulator layer 103, and a layer of material 105 for a first active layer 201 of first optical components 203 (not separately illustrated in FIG. 1 but illustrated and discussed further below with respect to FIG. 2). In an embodiment, at a beginning of the manufacturing process of the optical interposer 100, the first substrate 101, the first insulator layer 103, and the layer of material 105 for the first active layer 201 of first optical components 203 may collectively be part of a silicon-on-insulator (SOI) substrate. Looking first at the first substrate 101, the first substrate 101 may be a semiconductor material such as silicon or germanium, a dielectric material such as glass, or any other suitable material that allows for structural support of overlying devices.

The first insulator layer 103 may be a dielectric layer that separates the first substrate 101 from the overlying first active layer 201 and can additionally, in some embodiments, serve as a portion of cladding material that surrounds the subsequently manufactured first optical components 203 (discussed further below). In an embodiment the first insulator layer 103 may be silicon oxide, silicon nitride, germanium oxide, germanium nitride, combinations of these, or the like, formed using a method such as implantation (e.g., to form a buried oxide (BOX) layer) or else may be deposited onto the first substrate 101 using a deposition method such as chemical vapor deposition, atomic layer deposition, physical vapor deposition, combinations of these, or the like. However, any suitable material and method of manufacture may be used.

The material 105 for the first active layer 201 is initially (prior to patterning) a conformal layer of material that will be used to begin manufacturing the first active layer 201 of the first optical components 203. In an embodiment the material 105 for the first active layer 201 may be a translucent material that can be used as a core material for the desired first optical components 203, such as a semiconductor material such as silicon, germanium, silicon germanium, combinations of these, or the like, while in other embodiments the material 105 for the first active layer 201 may be a dielectric material such as silicon nitride or the like, although in other embodiments the material 105 for the first active layer 201 may be III-V materials, lithium niobate materials, or polymers. In embodiments in which the material 105 of the first active layer 201 is deposited, the material 105 for the first active layer 201 may be deposited using a method such as epitaxial growth, chemical vapor deposition, atomic layer deposition, physical vapor deposition, combinations of these, or the like. In other embodiments in which the first insulator layer 103 is formed using an implantation method, the material 105 of the first active layer 201 may initially be part of the first substrate 101 prior to the implantation process to form the first insulation layer 103. However, any suitable materials and methods of manufacture may be utilized to form the material 105 of the first active layer 201.

FIG. 2 illustrates that, once the material 105 for the first active layer 201 is ready, the first optical components 203 for the first active layer 201 are manufactured using the material 105 for the first active layer 201. In embodiments the first optical components 203 of the first active layer 201 may include such components as optical waveguides (e.g., ridge waveguides, rib waveguides, buried channel waveguides, diffused waveguides, etc.), couplers (e.g., grating couplers, edge couplers that are a narrowed waveguide with a width of between about 1 nm and about 200 nm, etc.), directional couplers, optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable first optical components 203 may be used.

To begin forming the first active layer 201 of first optical components 203 from the initial material, the material 105 for the first active layer 201 may be patterned into the desired shapes for the first active layer 201 of first optical components 203. In an embodiment the material 105 for the first active layer 201 may be patterned using, e.g., one or more photolithographic masking and etching processes. However, any suitable method of patterning the material 105 for the first active layer 201 may be utilized. For some of the first optical components 203, such as waveguides or edge couplers, the patterning process may be all or at least most of the manufacturing that is used to form these first optical components 203.

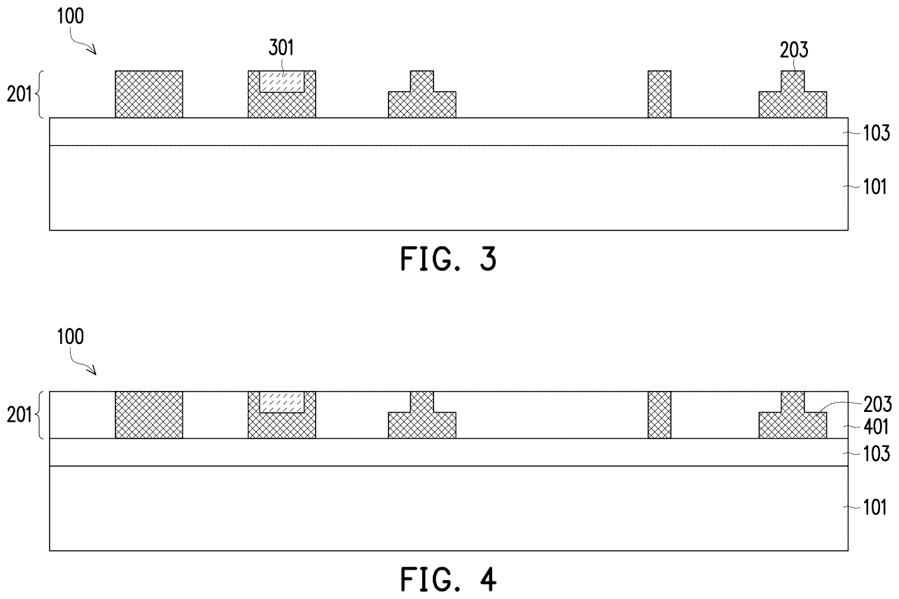

FIG. 3 illustrates that, for those components that utilize further manufacturing processes, such as Mach-Zehnder silicon-photonic switches that utilize resistive heating elements, additional processing may be performed either before or after the patterning of the material for the first active layer 201. For example, implantation processes, additional deposition and patterning processes for different materials (e.g., resistive heating elements, III-V materials for converters), combinations of all of these processes, or the like, can be utilized to help further the manufacturing of the various desired first optical components 203. In a particular embodiment, and as specifically illustrated in FIG. 3, in some embodiments an epitaxial deposition of a semiconductor material 301 such as germanium (used, e.g., for electricity/optics signal modulation and transversion) may be performed on a patterned portion of the material 105 of the first active layer 201. In such an embodiment the semiconductor material 301 may be epitaxially grown in order to help manufacture, e.g., a photodiode for an optical-to-electrical converter. All such manufacturing processes and all suitable first optical components 203 may be manufactured, and all such combinations are fully intended to be included within the scope of the embodiments.

FIG. 4 illustrates that, once the individual first optical components 203 of the first active layer 201 have been formed, a second insulator layer 401 may be deposited to cover the first optical components 203 and provide additional cladding material. In an embodiment the second insulator layer 401 may be a dielectric layer that separates the individual components of the first active layer 201 from each other and from the overlying structures and can additionally serve as another portion of cladding material that surrounds the first optical components 203. In an embodiment the second insulator layer 401 may be silicon oxide, silicon nitride, germanium oxide, germanium nitride, combinations of these, or the like, formed using a deposition method such as chemical vapor deposition, atomic layer deposition, physical vapor deposition, combinations of these, or the like. Once the material of the second insulator layer 401 has been deposited, the material may be planarized using, e.g., a chemical mechanical polishing process in order to either planarize a top surface of the second insulator layer 401 (in embodiments in which the second insulator layer 401 is intended to fully cover the first optical components 203) or else planarize the second insulator layer 401 with top surfaces of the first optical components 203. However, any suitable material and method of manufacture may be used.

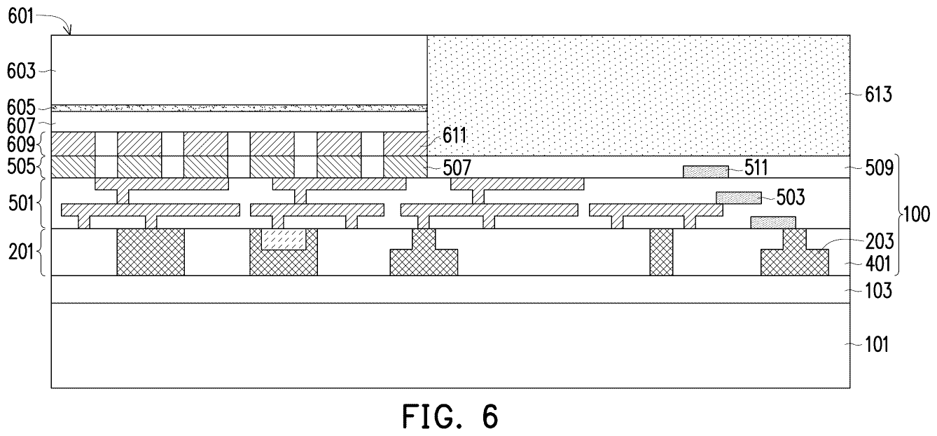

FIG. 5 illustrates that, once the first optical components 203 of the first active layer 201 have been manufactured and the second insulator layer 401 has been formed, first metallization layers 501 are formed in order to electrically connect the first active layer 201 of first optical components 203 to control circuitry, to each other, and to subsequently attached devices (not illustrated in FIG. 5 but illustrated and described further below with respect to FIG. 6). In an embodiment the first metallization layers 501 are formed of alternating layers of dielectric and conductive material and may be formed through any suitable processes (such as deposition, damascene, dual damascene, etc.). In particular embodiments there may be multiple layers of metallization used to interconnect the various first optical components 203, but the precise number of first metallization layers 501 is dependent upon the design of the optical interposer 100.

Additionally, during the manufacture of the first metallization layers 501, one or more second optical components 503 may be formed as part of the first metallization layers 501. In some embodiments the second optical components 503 of the first metallization layers 501 may include such components as couplers (e.g., edge couplers, grating couplers, etc.) for connection to outside signals, optical waveguides (e.g., ridge waveguides, rib waveguides, buried channel waveguides, diffused waveguides, etc.), optical modulators (e.g., Mach-Zehnder silicon-photonic switches, microelectromechanical switches, micro-ring resonators, etc.), amplifiers, multiplexors, demultiplexors, optical-to-electrical converters (e.g., P-N junctions), electrical-to-optical converters, lasers, combinations of these, or the like. However, any suitable optical components may be used for the one or more second optical components 503.

In an embodiment the one or more second optical components 503 may be formed by initially depositing a material for the one or more second optical components 503. In an embodiment the material for the one or more second optical components 503 may be a dielectric material such as silicon nitride, silicon oxide, combinations of these, or the like, or a semiconductor material such as silicon, deposited using a deposition method such as chemical vapor deposition, atomic layer deposition, physical vapor deposition, combinations of these, or the like. However, any suitable material and any suitable method of deposition may be utilized.

Once the material for the one or more second optical components 503 has been deposited or otherwise formed, the material may be patterned into the desired shapes for the one or more second optical components 503. In an embodiment the material of the one or more second optical components 503 may be patterned using, e.g., one or more photolithographic masking and etching processes. However, any suitable method of patterning the material for the one or more second optical components 503 may be utilized.

For some of the one or more second optical components 503, such as waveguides or edge couplers, the patterning process may be all or at least most manufacturing that is used to form these components. Additionally, for those components that utilize further manufacturing processes, such as Mach-Zehnder silicon-photonic switches that utilize resistive heating elements, additional processing may be performed either before or after the patterning of the material for the one or more second optical components 503. For example, implantation processes, additional deposition and patterning processes for different materials, combinations of all of these processes, or the like, can be utilized to help further the manufacturing of the various desired one or more second optical components 503. All such manufacturing processes and all suitable one or more second optical components 503 may be manufactured, and all such combinations are fully intended to be included within the scope of the embodiments.

Once the one or more second optical components 503 of the first metallization layers 501 have been manufactured, a first bonding layer 505 is formed over the first metallization layers 501. In an embodiment, the first bonding layer 505 may be used for a dielectric-to-dielectric and metal-to-metal bond. In accordance with some embodiments, the first bonding layer 505 is formed of a first dielectric material 509 such as silicon oxide, silicon nitride, or the like. The first dielectric material 509 may be deposited using any suitable method, such as CVD, high-density plasma chemical vapor deposition (HDPCVD), PVD, atomic layer deposition (ALD), or the like. However, any suitable materials and deposition processes may be utilized.

Once the first dielectric material 509 has been formed, first openings in the first dielectric material 509 are formed to expose conductive portions of the underlying layers in preparation to form first bond pads 507 within the first bonding layer 505. Once the first openings have been formed within the first dielectric material 509, the first openings may be filled with a seed layer and a plate metal to form the first bond pads 507 within the first dielectric material 509. The seed layer may be blanket deposited over top surfaces of the first dielectric material 509 and the exposed conductive portions of the underlying layers and sidewalls of the openings and the second openings. The seed layer may comprise a copper layer. The seed layer may be deposited using processes such as sputtering, evaporation, or plasma-enhanced chemical vapor deposition (PECVD), or the like, depending upon the desired materials. The plate metal may be deposited over the seed layer through a plating process such as electrical or electro-less plating. The plate metal may comprise copper, a copper alloy, or the like. The plate metal may be a fill material. A barrier layer (not separately illustrated) may be blanket deposited over top surfaces of the first dielectric material 509 and sidewalls of the openings and the second openings before the seed layer. The barrier layer may comprise titanium, titanium nitride, tantalum, tantalum nitride, or the like.

Following the filling of the first openings, a planarization process, such as a CMP, is performed to remove excess portions of the seed layer and the plate metal, forming the first bond pads 507 within the first bonding layer 505. In some embodiments a bond pad via (not separately illustrated) may also be utilized to connect the first bond pads 507 with underlying conductive portions and, through the underlying conductive portions, connect the first bond pads 507 with the first metallization layers 501.

Additionally, the first bonding layer 505 may also include one or more third optical components 511 incorporated within the first bonding layer 505. In such an embodiment, prior to the deposition of the first dielectric material 509, the one or more third optical components 511 may be manufactured using similar methods and similar materials as the one or more second optical components 503 (described above), such as by being waveguides and other structures formed at least in part through a deposition and patterning process. However, any suitable structures, materials and any suitable methods of manufacture may be utilized.

FIG. 6 illustrates a bonding of a first semiconductor device 601 to the first bonding layer 505 of the optical interposer 100. In some embodiments, the first semiconductor device 601 is an electronic integrated circuit (EIC—e.g., a device without optical devices) and may have a semiconductor substrate 603, a layer of active devices 605, an overlying interconnect structure 607, a second bonding layer 609, and associated third bond pads 611. In an embodiment the semiconductor substrate 603 may be similar to the first substrate 101 (e.g., a semiconductor material such as silicon or silicon germanium), the active devices 605 may be transistors, capacitors, resistors, and the like formed over the semiconductor substrate 603, the interconnect structure 607 may be similar to the first metallization layers 501 (without optical components), the second bonding layer 609 may be similar to the first bonding layer 505, and the third bond pads 611 may be similar to the first bond pads 507. However, any suitable devices may be utilized.

In an embodiment the first semiconductor device 601 may be configured to work with the optical interposer 100 for a desired functionality. In some embodiments the first semiconductor device 601 may be a high bandwidth memory (HBM) module, an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

In an embodiment the first semiconductor device 601 and the first bonding layer 505 may be bonded using a dielectric-to-dielectric and metal-to-metal bonding process. In a particular embodiment which utilizes a dielectric-to-dielectric and metal-to-metal bonding process, the process may be initiated by activating the surfaces of the second bonding layer 609 and the surfaces of the first bonding layer 505. Activating the top surfaces of the first bonding layer 505 and the second bonding layer 609 may comprise a dry treatment, a wet treatment, a plasma treatment, exposure to an inert gas plasma, exposure to H₂, exposure to N₂, exposure to O₂, combinations thereof, or the like, as examples. In embodiments where a wet treatment is used, an RCA cleaning may be used, for example. In another embodiment, the activation process may comprise other types of treatments. The activation process assists in the bonding of the first bonding layer 505 and the second bonding layer 609.

After the activation process the optical interposer 100 and the first semiconductor device 601 may be cleaned using, e.g., a chemical rinse, and then the first semiconductor device 601 is aligned and placed into physical contact with the optical interposer 100. The optical interposer 100 and the first semiconductor device 601 are then subjected to thermal treatment and contact pressure to bond the optical interposer 100 and the first semiconductor device 601. For example, the optical interposer 100 and the first semiconductor device 601 may be subjected to a pressure of about 200 kPa or less, and a temperature between about 25° C. and about 250° C. to fuse the optical interposer 100 and the first semiconductor device 601. The optical interposer 100 and the first semiconductor device 601 may then be subjected to a temperature at or above the eutectic point for material of the first bond pads 507 and the third bond pads 611, e.g., between about 150° C. and about 650° C., to fuse the metal. In this manner, the optical interposer 100 and the first semiconductor device 601 forms a dielectric-to-dielectric and metal-to-metal bonded device. In some embodiments, the bonded dies are subsequently baked, annealed, pressed, or otherwise treated to strengthen or finalize the bond.

Additionally, while specific processes have been described to initiate and strengthen the bonds, these descriptions are intended to be illustrative and are not intended to be limiting upon the embodiments. Rather, any suitable combination of baking, annealing, pressing, or combination of processes may be utilized. All such processes are fully intended to be included within the scope of the embodiments.

FIG. 6 additionally illustrates that, once the first semiconductor device 601 has been bonded, a first gap-fill material 613 is deposited in order to fill the space around the first semiconductor device 601 and provide additional support. In an embodiment the first gap-fill material 613 may be a material such as silicon oxide, silicon nitride, silicon oxynitride, combinations of these, or the like, deposited to fill and overfill the spaces around the first semiconductor device 601. However, any suitable material and method of deposition may be utilized.

Once the first gap-fill material 613 has been deposited, the first gap-fill material 613 may be planarized in order to expose the first semiconductor device 601. In an embodiment the planarization process may be a chemical mechanical planarization process, a grinding process, or the like. However, any suitable planarization process may be utilized.

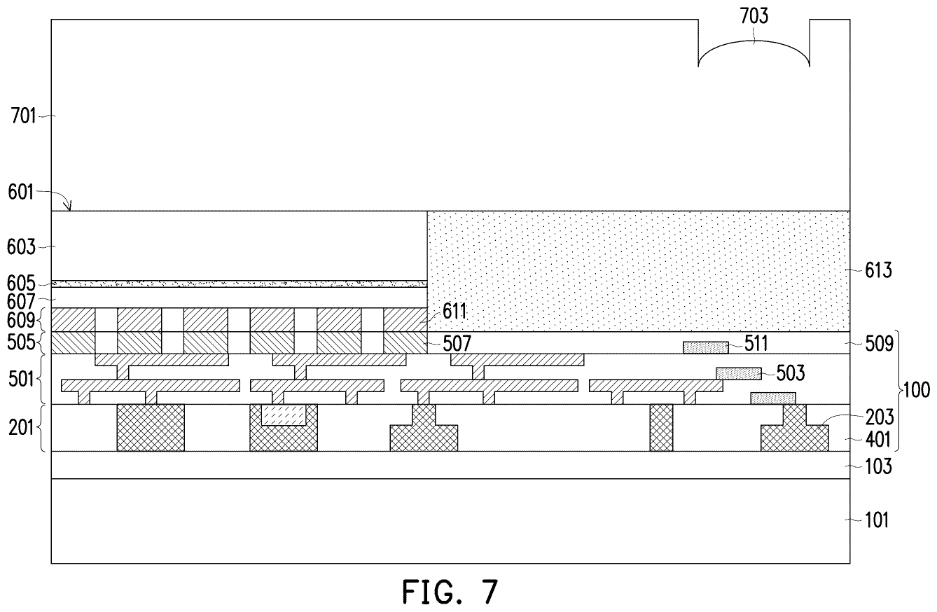

FIG. 7 illustrates an attachment of a first support substrate 701 to the first semiconductor device 601 and the first gap-fill material 613. In an embodiment the first support substrate 701 may be a support material that is transparent to the wavelength of light that is desired to be used, such as silicon, and may be attached using, e.g., an adhesive (not separately illustrated in FIG. 7). However, in other embodiments the first support substrate 701 may be bonded to the first semiconductor device 601 and the first gap-fill material 613 using, e.g., a bonding process. Any suitable method of attaching the first support substrate 701 may be used.

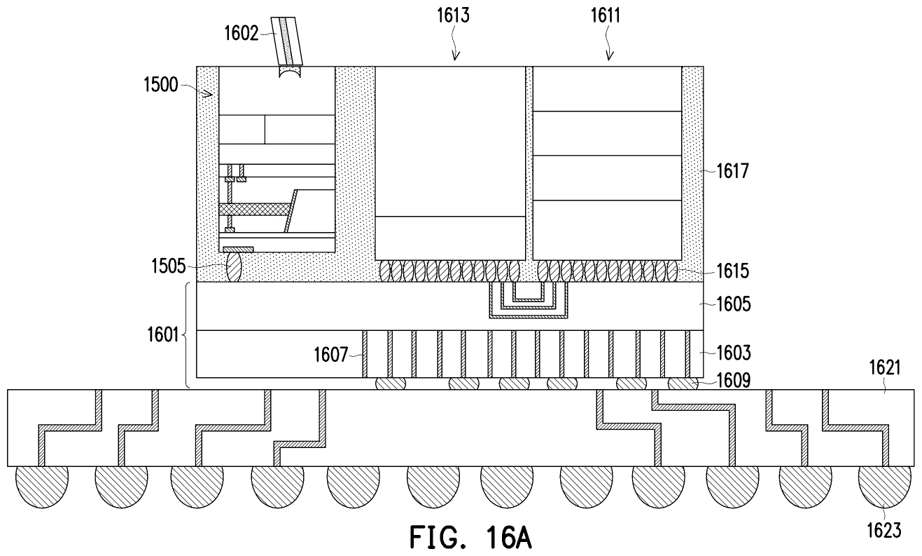

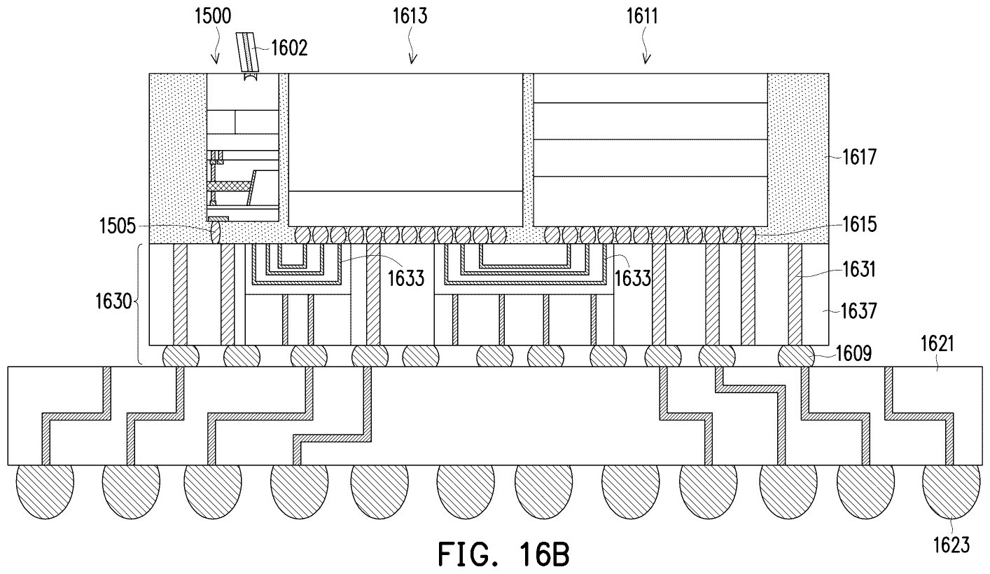

FIG. 7 additionally illustrates that the first support substrate 701 comprises a first coupling lens 703 positioned to facilitate movement from an optical fiber 1602 (not illustrated in FIG. 7 but illustrated and described further below with respect to FIG. 16A). In an embodiment the first coupling lens 703 may be formed by shaping the material of the support substrate (e.g., silicon) using masking and etching processes. However, any suitable process may be utilized.

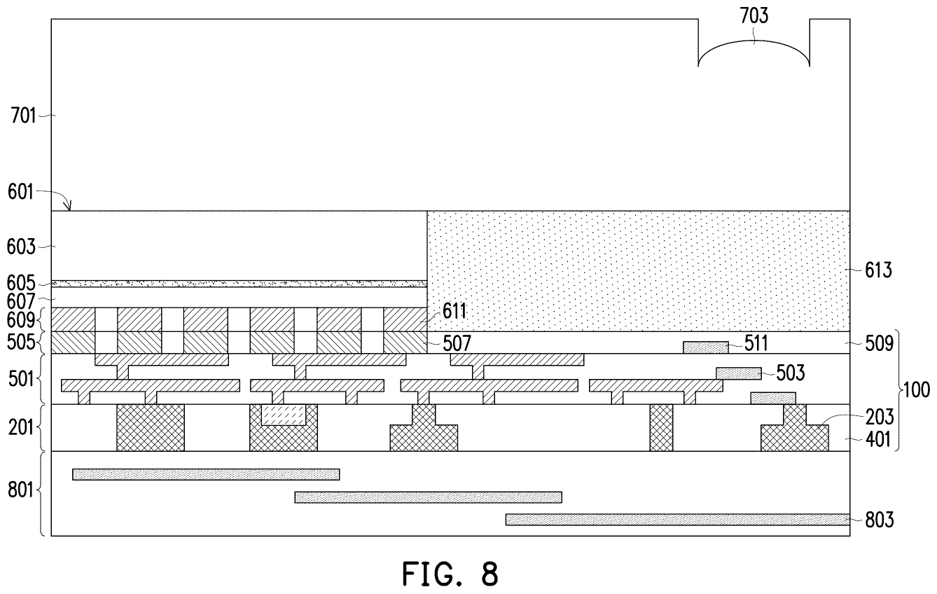

FIG. 8 illustrates a removal of the first substrate 101 and, optionally, the first insulator layer 103, thereby exposing the first active layer 201 of first optical components 203. In an embodiment the first substrate 101 and the first insulator layer 103 may be removed using a planarization process, such as a chemical mechanical polishing process, a grinding process, one or more etching processes, combinations of these, or the like. However, any suitable method may be used in order to remove the first substrate 101 and/or the first insulator layer 103.

Once the first substrate 101 and the first insulator layer 103 have been removed, a second active layer 801 of fourth optical components 803 may be formed on a back side of the first active layer 201. In an embodiment the second active layer 801 of fourth optical components 803 may be formed using similar materials and similar processes as the second optical components 503 of the first metallization layers 501 (described above with respect to FIG. 5). For example, the second active layer 801 of fourth optical components 803 may be formed of alternating layers of a cladding material such as silicon oxide and core material such as silicon nitride formed using deposition and patterning processes in order to form optical components such as waveguides and the like.

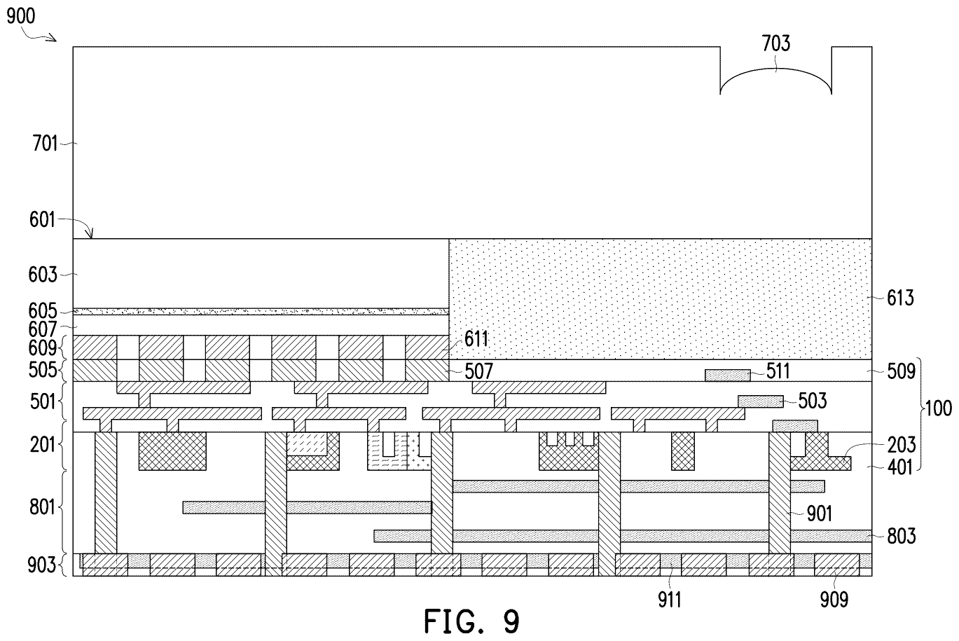

FIG. 9 illustrates formation of first through device vias (TDVs) 901, formation of a third bonding layer 903 to form a first optical package 900. In an embodiment the first through device vias 901 extend through the second active layer 801 and the first active layer 201 so as to provide a quick passage of power, data, and ground through the optical interposer 100. In an embodiment the first through device vias 901 may be formed by initially forming through device via openings into the optical interposer 100. The through device via openings may be formed by applying and developing a suitable photoresist (not shown), and removing portions of the second active layer 801 and the optical interposer 100 that are exposed.

Once the through device via openings have been formed within the optical interposer 100, the through device via openings may be lined with a liner. The liner may be, e.g., an oxide formed from tetraethylorthosilicate (TEOS) or silicon nitride, although any suitable dielectric material may alternatively be used. The liner may be formed using a plasma enhanced chemical vapor deposition (PECVD) process, although other suitable processes, such as physical vapor deposition or a thermal process, may also be used.

Once the liner has been formed along the sidewalls and bottom of the through device via openings, a barrier layer (also not independently illustrated) may be formed and the remainder of the through device via openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer (not shown), filling and overfilling the through device via openings. Once the through device via openings have been filled, excess liner, barrier layer, seed layer, and first conductive material outside of the through device via openings may be removed through a planarization process such as chemical mechanical polishing (CMP), although any suitable removal process may be used.

Optionally, in some embodiments once the first through device vias 901 have been formed, second metallization layers (not separately illustrated in FIG. 9) may be formed in electrical connection with the first through device vias 901. In an embodiment the second metallization layers may be formed as described above with respect to the first metallization layers 501, such as being alternating layers of dielectric and conductive materials using damascene processes, dual damascene process, or the like. In other embodiments, the second metallization layers may be formed using a plating process to form and shape conductive material, and then cover the conductive material with a dielectric material. However, any suitable structures and methods of manufacture may be utilized.

The third bonding layer 903 is formed in order to provide electrical connections between the optical interposer 100 and subsequently attached devices. In an embodiment the third bonding layer 903 may be similar to the first bonding layer 505, such as having third bond pads 909 (similar to the first bond pads 507) and even fifth optical components 911 (similar to the third optical components 511). However, any suitable devices may be utilized.

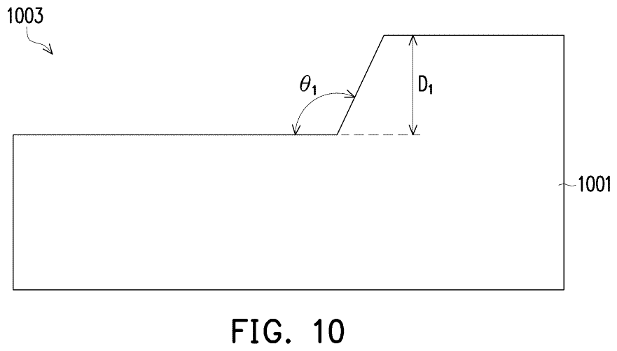

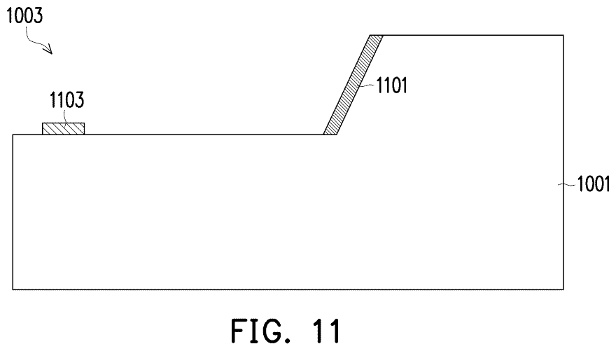

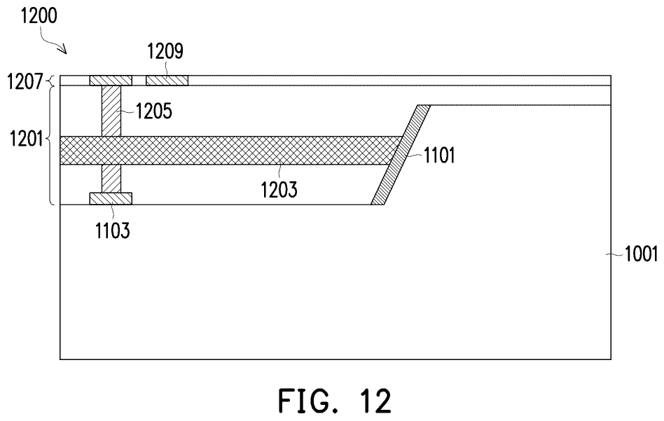

FIG. 10 illustrates a start of a manufacturing process to form a mirror structure 1200 (not illustrated in FIG. 10 but illustrated and described further below with respect to FIG. 12) for use with the optical interposer 100. In an embodiment the manufacturing process for the mirror structure 1200 begins with a second substrate 1001. In an embodiment the second substrate 1001 may be similar to the first substrate 101 described above with respect to FIG. 1. For example, the second substrate 1001 may be a silicon substrate. However, any suitable materials may be utilized.

FIG. 10 additionally illustrates a patterning of the second substrate 1001 in order to form a first recess 1003 within the second substrate 1001. In an embodiment the first recess 1003 may be formed using one or more photolithographic masking and etching processes, such as one or more wet etching processes or dry etching processes. However, any suitable process may be utilized.

In a particular embodiment the first recess may be formed to have a first depth D1 from a top surface of the second substrate 1001 of between about 10 μm and about 30 μm. Additionally, a first angle θ1 between a bottom surface of the first recess 1003 and a sidewall of the first recess 1003 may be between about 40° and about 50°. However, any suitable dimensions may be utilized.

FIG. 11 illustrates a formation of a first mirror coating 1101 along the sidewall of the first recess 1003. In an embodiment the first mirror coating 1101 may be a single layer of a reflective material such as aluminum copper, copper, gold, aluminum, combinations of these, or the like, or else may be a multi-layer structure such as a Bragg's reflector comprising alternating layers of silicon dioxide and amorphous silicon. The individual materials of the mirror coating may be deposited using any suitable methods, such as chemical vapor deposition, physical vapor deposition, plating, combinations of these, or the like, and the individual layers may be then be further patterned using, e.g., a photolithographic masking and etching process (for example, to remove horizontal portions of the deposited materials). The material for the first mirror coating 1101 may be deposited to a thickness of between about 500 Å and about 3000 Å. However, any suitable materials and methods may be utilized in order to form the first mirror coating 1101 along the sidewalls of the first recess 1003.

FIG. 11 additionally illustrates formation of contact pads 1103 along a bottom surface of the first recess 1003. In an embodiment in which the first mirror coating 1101 is a conductive material such as aluminum copper, the contact pads 1103 may be formed simultaneously with the first mirror coating 1101 using, e.g., the deposition and patterning process described above. In other embodiments, the contact pads 1103 may be formed separately from the first mirror coating 1101, using either a similar process or a different process from the first mirror coating 1101. Any suitable materials and methods of manufacture may be utilized.

FIG. 12 illustrates that, once the mirror coating 1101 has been formed, a third active layer 1201 of fifth optical components 1203 may be formed over the second substrate 1001 and within the first recess 1003. In an embodiment the third active layer 1201 of fifth optical components 1203 may be formed using similar materials and similar processes as the second optical components 503 of the first metallization layers 501 (described above with respect to FIG. 5). For example, the third active layer 1201 of fifth optical components 1203 may be formed of alternating layers of a cladding material such as silicon oxide and core material such as silicon nitride formed using deposition and patterning processes in order to form optical components such as waveguides and the like.

In a particular embodiment the third active layer 1201 of fifth optical components 1203 comprises at least one waveguide (e.g., a silicon nitride waveguide) that is aligned with the first mirror coating 1101 in order to transmit and receive optical signals in conjunction with the first mirror coating 1101. In such an embodiment the waveguide may further comprise an edge coupler formed within the waveguide and located to transmit and receive optical signals reflected from the first mirror coating 1101 and at least one waveguide with a tapered end in order to transmit and receive optical signals from waveguides within the first optical package 900. However, any other suitable structures or optical components may be formed and utilized within the third active layer 1201 of fifth optical components 1203.

FIG. 12 additionally illustrates formation of second through device vias (TDVs) 1205 that extend through the third active layer 1201 to make electrical contact with the contact pads 1103 and provide quick passage of power and signals through the mirror structure 1200. In an embodiment the second through device vias 1205 may be formed using similar materials and similar processes as the first through device vias 901 described above with respect to FIG. 9. However, any suitable processes and materials may be utilized.

FIG. 12 additionally illustrates formation of a fourth bonding layer 1207 in order to provide electrical connections between the mirror structure 1200 and subsequently attached devices. In an embodiment the fourth bonding layer 1207 may be similar to the first bonding layer 505, such as having fourth bond pads 1209 (similar to the first bond pads 507) and even, optionally, sixth optical components (similar to the third optical components 511). For example, the fourth bond pads 1209 may be formed by initially forming a dielectric layer, patterning the dielectric layer to form openings, filling the openings with a conductive material, and planarizing the conductive material using, e.g., a chemical mechanical planarization process. However, any suitable materials and methods may be utilized.

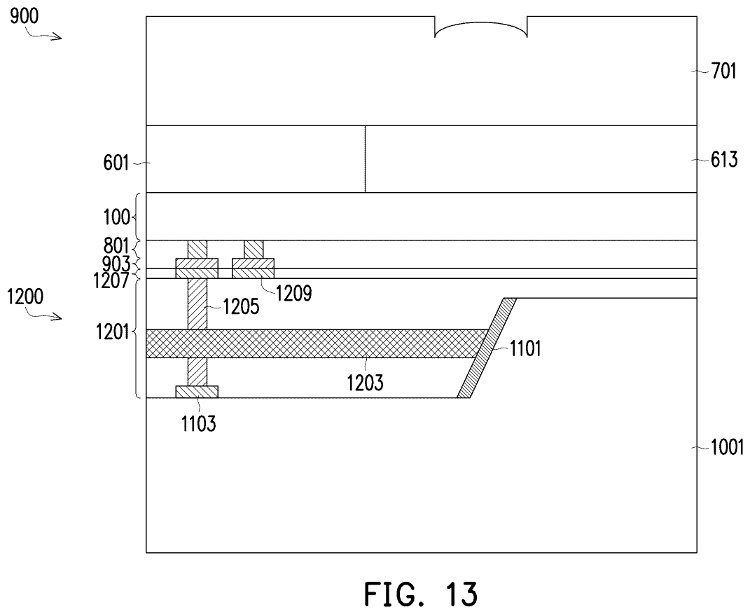

FIG. 13 illustrates a bonding of the mirror structure 1200 to the first optical package 900 (wherein the first optical package 900 is illustrated in a simplified form for clarity). In an embodiment the mirror structure 1200 may be bonded to the first optical package 900 by bonding the third bonding layer 903 to the fourth bonding layer 1207 using, e.g., a hybrid bonding process, similar to the hybrid bonding process described above with respect to FIG. 6. However, any suitable bonding process may be utilized.

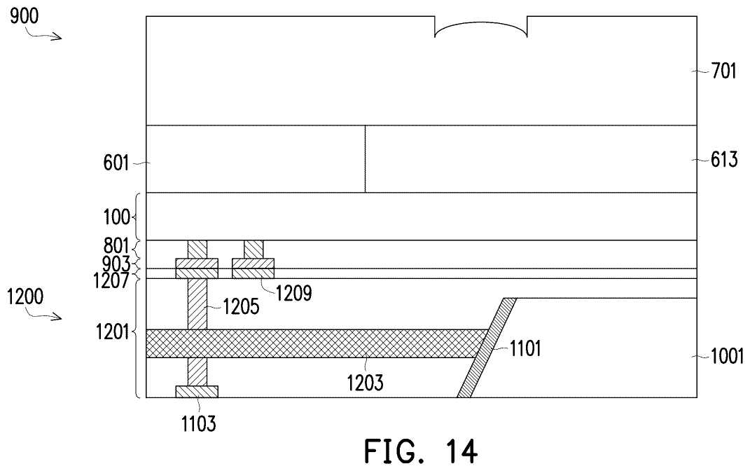

FIG. 14 illustrates that, once the mirror structure 1200 has been bonded to the first optical package 900, a portion of the second substrate 1001 may be removed in order to expose the contact pads 1103 for further processing. In an embodiment the removal may be performed using one or more removal processes such as one or more etching or planarization processes. In a particular embodiment the removal process may be a chemical mechanical polishing process. However, any suitable process may be utilized.

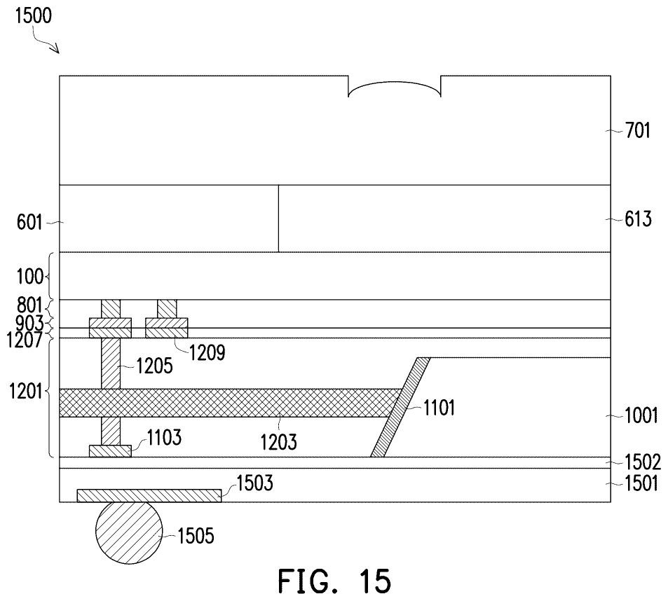

FIG. 15 illustrates that, once the contact pads 1103 have been exposed, a first passivation layer 1502 and a second passivation layer 1501 may be deposited to protect the overall structure, second contact pads 1503 may be formed, and first external connectors 1505 may be placed on the second contact pads 1503, in order to form a first optical package 1500. Looking first at the first passivation layer 1502, the first passivation layer 1502 may be a dielectric material such as silicon nitride, silicon oxide, silicon oxynitride, combinations of these, or the like, deposited using a method such as chemical vapor deposition, physical vapor deposition, atomic layer deposition, combinations of these, or the like. However, any suitable materials and processes may be utilized.

Looking next at the second passivation layer 1501, the second passivation layer 1501 may be a dielectric material such as polyimide, silicon nitride, silicon oxide, silicon oxynitride, combinations of these, or the like, deposited using a method such as chemical vapor deposition, physical vapor deposition, atomic layer deposition, combinations of these, or the like. However, any suitable materials and processes may be utilized.

The second contact pads 1503 are formed to provide an electrical connection to the contact pads 1103 by redistribution lines formed through the first passivation layer 1502 and the second passivation layer 1501. In an embodiment the second contact pads 1503 may be formed using similar processes and materials as the first bond pads 507 described above with respect to FIG. 5. However, any suitable methods and materials may be utilized.

The first external connectors 1505 may be conductive bumps (e.g., C4 bumps, ball grid arrays, microbumps, etc.) or conductive pillars utilizing materials such as solder and copper. In an embodiment in which the first external connectors 1505 are contact bumps, the first external connectors 1505 may comprise a material such as tin, or other suitable materials, such as silver, lead-free tin, or copper. In an embodiment in which the first external connectors 1505 are tin solder bumps, the first external connectors 1505 may be formed by initially forming a layer of tin through such commonly used methods such as evaporation, electroplating, printing, solder transfer, ball placement, etc. Once a layer of tin has been formed on the structure, a reflow may be performed in order to shape the material into the desired bump shape.

By using the second substrate 1001 to provide additional structural support, the overall thickness of the first optical package 1500 may be reduced. For example, the first optical package 1500 may have a thickness of less than about 800 μm. However, any suitable dimensions may be utilized.

FIG. 16A illustrates that, once the first optical package 1500 has been formed, the first optical package 1500 may be attached to an interposer substrate 1601 that is used to couple the first optical package 1500 with other devices to form, for example, a chip-on-wafer-on-substrate (CoWoS®). In an embodiment the interposer substrate 1601 comprises a semiconductor substrate 1603, third metallization layers 1605, third through device vias (TDVs) 1607, and second external connectors 1609. The semiconductor substrate 1603 may comprise bulk silicon, doped or undoped, or an active layer of a silicon-on-insulator (SOI) substrate. Generally, an SOI substrate comprises a layer of a semiconductor material such as silicon, germanium, silicon germanium, SOI, silicon germanium on insulator (SGOI), or combinations thereof. Other substrates that may be used include multi-layered substrates, gradient substrates, or hybrid orientation substrates.

Optionally, first active devices (not separately illustrated) may be added to the semiconductor substrate 1603. The first active devices comprise a wide variety of active devices and passive devices such as capacitors, resistors, inductors and the like that may be used to generate the desired structural and functional requirements of the design for the semiconductor substrate 1603. The first active devices may be formed using any suitable methods either within or else on the semiconductor substrate 1603.

The third metallization layers 1605 are formed over the semiconductor substrate 1603 and the first active devices and are designed to connect the various devices to form functional circuitry. In an embodiment the third metallization layers 1605 are formed of alternating layers of dielectric (e.g., low-k dielectric materials, extremely low-k dielectric material, ultra low-k dielectric materials, combinations of these, or the like) and conductive material and may be formed through any suitable process (such as deposition, damascene, dual damascene, etc.). However, any suitable materials and processes may be utilized.

Additionally, at any desired point in the manufacturing process, the third TDVs 1607 may be formed within the semiconductor substrate 1603 and, if desired, one or more layers of the third metallization layers 1605, in order to provide electrical connectivity from a front side of the semiconductor substrate 1603 to a back side of the semiconductor substrate 1603. In an embodiment the third TDVs 1607 may be formed by initially forming through device via (TDV) openings into the semiconductor substrate 1603 and, if desired, any of the overlying third metallization layers 1605 (e.g., after the desired third metallization layer 1605 has been formed but prior to formation of the next overlying third metallization layer 1605). The TDV openings may be formed by applying and developing a suitable photoresist, and removing portions of the underlying materials that are exposed to a desired depth. The TDV openings may be formed so as to extend into the semiconductor substrate 1603 to a depth greater than the eventual desired height of the semiconductor substrate 1603.

Once the TDV openings have been formed within the semiconductor substrate 1603 and/or any third metallization layers 1605, the TDV openings may be lined with a liner. The liner may be, e.g., an oxide formed from tetraethylorthosilicate (TEOS) or silicon nitride, although any suitable dielectric material may be used. The liner may be formed using a plasma enhanced chemical vapor deposition (PECVD) process, although other suitable processes, such as physical vapor deposition or a thermal process, may be used.

Once the liner has been formed along the sidewalls and bottom of the TDV openings, a barrier layer may be formed and the remainder of the TDV openings may be filled with first conductive material. The first conductive material may comprise copper, although other suitable materials such as aluminum, alloys, doped polysilicon, combinations thereof, and the like, may be utilized. The first conductive material may be formed by electroplating copper onto a seed layer, filling and overfilling the TDV openings. Once the TDV openings have been filled, excess liner, barrier layer, seed layer, and first conductive material outside of the TDV openings may be removed through a planarization process such as chemical mechanical polishing (CMP), although any suitable removal process may be used.

Once the TDV openings have been filled, the semiconductor substrate 1603 may be thinned until the third TDVs 1607 have been exposed. In an embodiment the semiconductor substrate 1603 may be thinned using, e.g., a chemical mechanical polishing process, a grinding process, or the like. Further, once exposed, the semiconductor substrate 1603 may be recessed using, e.g., one or more etching processes, such as a wet etch process in order to recess the semiconductor substrate 1603 so that the third TDVs 1607 extend out of the semiconductor substrate 1603.

In an embodiment the second external connectors 1609 may be placed on the semiconductor substrate 1603 in electrical connection with the third TDVs 1607 and may be, e.g., a ball grid array (BGA) which comprises a eutectic material such as solder, although any suitable materials may be used. Optionally, an underbump metallization or additional metallization layers (not separately illustrated in FIG. 16A) may be utilized between the semiconductor substrate 1603 and the second external connectors 1609. In an embodiment in which the second external connectors 1609 are solder bumps, the second external connectors 1609 may be formed using a ball drop method, such as a direct ball drop process. In another embodiment, the solder bumps may be formed by initially forming a layer of tin through any suitable method such as evaporation, electroplating, printing, solder transfer, and then performing a reflow in order to shape the material into the desired bump shape. Once the second external connectors 1609 have been formed, a test may be performed to ensure that the structure is suitable for further processing.

Once the interposer substrate 1601 has been formed, the first optical package 1500 may be attached to the interposer substrate 1601. In an embodiment the first optical package 1500 may be attached to the interposer substrate 1601 by aligning the first external connectors 1505 with conductive portions of the interposer substrate 1601. Once aligned and in physical contact, the first external connectors 1505 are reflowed by raising the temperature of the first external connectors 1505 past a eutectic point of the first external connectors 1505, thereby shifting the material of the first external connectors 1505 to a liquid phase. Once reflowed, the temperature is reduced in order to shift the material of the first external connectors 1505 back to a solid phase, thereby bonding the first optical package 1500 to the interposer substrate 1601.

FIG. 16A additionally illustrates a bonding of a second semiconductor device 1611 and a third semiconductor device 1613 onto the semiconductor substrate 1603. In some embodiments, the second semiconductor device 1611 is an electronic integrated circuit (EIC) such as a stacked device that includes multiple, interconnected semiconductor substrates. For example, the second semiconductor device 1611 may be a memory device such as a high bandwidth memory (HBM) module, a hybrid memory cube (HMC) module, or the like that includes multiple stacked memory dies. In such embodiments, the second semiconductor device 1611 includes multiple semiconductor substrates interconnected by through device vias (TDVs). Each of the semiconductor substrates may (or may not) have a layer of active devices and an overlying interconnect structure, a bond layer, and associated bond pads in order to interconnect the multiple devices within the second semiconductor device 1611.

Of course, while the second semiconductor device 1611 is a HBM module in one embodiment, the embodiments are not restricted to the second semiconductor device 1611 being an HBM module. Rather, the second semiconductor device 1611 may be any suitable semiconductor device, such as a processor die or other type of functional die. In particular embodiments the second semiconductor device 1611 may be an xPU, a logic die, a 3DIC die, a CPU, a GPU, a SoC die, a MEMS die, combinations of these, or the like. Any suitable device with any suitable functionality, may be used, and all such devices are fully intended to be included within the scope of the embodiments.

The third semiconductor device 1613 may be another EIC that is intended to work with both the first optical package 1500 and the second semiconductor device 1611. In some embodiments the third semiconductor device 1613 may have a different functionality from the second semiconductor device 1611, such as by being an GPU, an ASIC device, or may have a same functionality as the second semiconductor device 1611, such as by being another high bandwidth memory device.

In an embodiment both the second semiconductor device 1611 and the third semiconductor device 1613 may be bonded to the interposer substrate 1601 using, e.g., third external connections 1615. The third external connections 1615 may be conductive bumps (e.g., ball grid arrays, microbumps, etc.) or conductive pillars utilizing materials such as solder and copper. In an embodiment in which the third external connections 1615 are contact bumps, the third external connections 1615 may comprise a material such as tin, or other suitable materials, such as silver, lead-free tin, or copper. In an embodiment in which the third external connections 1615 are tin solder bumps, the third external connections 1615 may be formed by initially forming a layer of tin through such commonly used methods such as evaporation, electroplating, printing, solder transfer, ball placement, etc. Once a layer of tin has been formed on the structure, a reflow may be performed in order to shape the material into the desired bump shape.

Additionally, once the third external connections 1615 have been placed, the second semiconductor device 1611 and the third semiconductor device 1613 are aligned with the interposer substrate 1601. Once aligned and in physical contact, the third external connections 1615 are reflowed by raising the temperature of the third external connections 1615 past a eutectic point of the third external connections 1615, thereby shifting the material of the third external connections 1615 to a liquid phase. Once reflowed, the temperature is reduced in order to shift the material of the third external connections 1615 back to a solid phase, thereby bonding the second semiconductor device 1611 and the third semiconductor device 1613 to the interposer substrate 1601.

Optionally, an underfill material (not separately illustrated) may be placed. The underfill material may reduce stress and protect the joints resulting from the reflowing of the third external connections 1615 and the first external connectors 1505. The underfill material may be formed by a capillary flow process after the first optical package 1500, the second semiconductor device 1611 and the third semiconductor device 1613 are attached.

After the underfill material has been placed, the second semiconductor device 1611, the third semiconductor device 1613, and the first optical package 1500 are encapsulated with an encapsulant 1617. In an embodiment, the encapsulant 1617 may be a molding compound, epoxy, or the like. The encapsulant 1617 may be applied by compression molding, transfer molding, or the like. The encapsulant 1617 is further placed in gap regions between the second semiconductor device 1611, the third semiconductor device 1613, and the first optical package 1500. The encapsulant 1617 may be applied in liquid or semi-liquid form and then subsequently cured.

A planarization process is performed on the encapsulant 1617 once the encapsulant 1617 has been placed. Once planarized, top surfaces of the encapsulant 1617, the second semiconductor device 1611, the third semiconductor device 1613, and the first optical package 1500 are substantially coplanar after the planarization process within process variations. The planarization process may be, for example, a chemical-mechanical polish (CMP), a grinding process, or the like. In some embodiments, the planarization may be omitted.

Once the second semiconductor device 1611, the third semiconductor device 1613 and the first optical package 1500 have been bonded to the interposer substrate 1601, the interposer substrate 1601 may be bonded to a second substrate 1621 with, e.g., the second external connectors 1609. In an embodiment the second substrate 1621 may be a package substrate, which may be a printed circuit board (PCB) or the like. The second substrate 1621 may include one or more dielectric layers and electrically conductive features, such as conductive lines and vias. In some embodiments, the second substrate 1621 may include through-vias, active devices, passive devices, and the like. The second substrate 1621 may further include conductive pads formed at the upper and lower surfaces of the second substrate 1621.

The second external connectors 1609 may be aligned with corresponding conductive connections on the second substrate 1621. Once aligned the second external connectors 1609 may then be reflowed in order to bond the second substrate 1621 to the interposer substrate 1601. However, any suitable bonding process may be used to connect the interposer substrate 1601 to the second substrate 1621.

Additionally, the second substrate 1621 may be prepared for further processing by placing by forming fourth external connections 1623 on an opposite side of the second substrate 1621 from the first optical package 1500. In an embodiment the fourth external connections 1623 may be formed using similar processes and materials as the second external connectors 1609. However, any suitable materials and processes may be utilized.

Optionally at this point in the process, an optical fiber 1602 may be attached. In an embodiment the optical fiber 1602 is utilized as an optical input/output port to the optical interposer 100 through the third active layer 1201. In an embodiment the optical fiber 1602 is placed so as to optically couple the optical fiber 1602 to the first mirror coating 1101 so that light from the optical fiber 1602 reflects off of the first mirror coating 1101 and into the fifth optical components 1203, such as an edge coupler formed within the fifth optical components 1203. From the fifth optical components 1203, the light may be routed into the optical interposer 100. Similarly, the optical fiber 1602 is positioned so that optical signals leaving the fifth optical components 1203 is directed into the optical fiber 1602 for transmission. However, any suitable location may be utilized.

The optical fiber 1602 may be held in place using, e.g., an optical glue (not separately illustrated). In some embodiments, the optical glue comprises a polymer material such as epoxy-acrylate oligomers, and may have a refractive index between about 1 and about 3. However, any suitable material may be utilized.

Additionally, while the optical fiber 1602 is illustrated as being attached at this point in the manufacturing process, this is intended to be illustrative and is not intended to be limiting. Rather, the optical fiber 1602 may be attached at any suitable point in the process. Any suitable point of attachment may be utilized, and all such attachments at any point in the process are fully intended to be included within the scope of the embodiments.

In operation, the optical fiber 1602 can supply an optical signal which traverses through the first support substrate 701 and the first gap-fill material 613 and impacts the first mirror coating 1101. The first mirror coating 1101 reflects the optical signal towards the fifth optical components 1203, where the optical signal is received by an edge coupler and enters the third active layer 1201 of the fifth optical components 1203. The third active layer 1201 of the fifth optical components 1203 can then route the optical signal to the optical interposer 100 using, e.g., waveguides that have tapered ends. Similarly, the optical interposer 100 can route an optical signal to the third active layer 1201 of the fifth optical components 1203 which routes the optical signal to the first mirror coating 1101, which reflects the transmitted optical signal to the optical fiber 1602.

FIG. 16B illustrates a variation where the first optical package 1500, the second semiconductor device 1611, and the third semiconductor device 1613 are bonded to an integrated fan-out substrate 1630. In this embodiment InFO TDVs 1631 are initially formed (using, e.g., a photolithographic masking and plating process) on a substrate (not separately illustrated) adjacent to a fourth semiconductor device 1633 and a fifth semiconductor device 1635, which may be similar to the second semiconductor device 1611 and/or the third semiconductor device 1613, or else may be connection die such as a local silicon interconnect (LSI). Once in place, the InFO TDVs 1631, the fourth semiconductor device 1633, and the fifth semiconductor device 1635 are encapsulated with a second encapsulant 1637 (similar to the encapsulant 1617), and the substrate is removed to form a polymer-based organic interposer.

Once the InFO package 1630 has been formed, the second semiconductor device 1611 and the third semiconductor device 1613 may be bonded to the InFO substrate 1630 using the third external connections 1615 and the first optical package 1500 is attached using the first external connectors 1505. Additionally, the InFO substrate 1630 may be bonded to the second substrate 1621 using, e.g., the second external connectors 1609, and the fourth external connections 1623 are formed on the second substrate 1621. However, any suitable processes and structures may be utilized.

By bonding the optical engine with the second substrate 1001, the first optical package 900 can be manufactured with a stronger mechanical strength. Additionally, by using the first mirror coating 1101, an edge coupler can be utilized to make the transfer of signals to and from an optical fiber, avoiding the losses associated with grating couplers. As such, a stronger device with less losses can be incorporated into advanced packages, such as chip-on-wafer-on substrate packages.

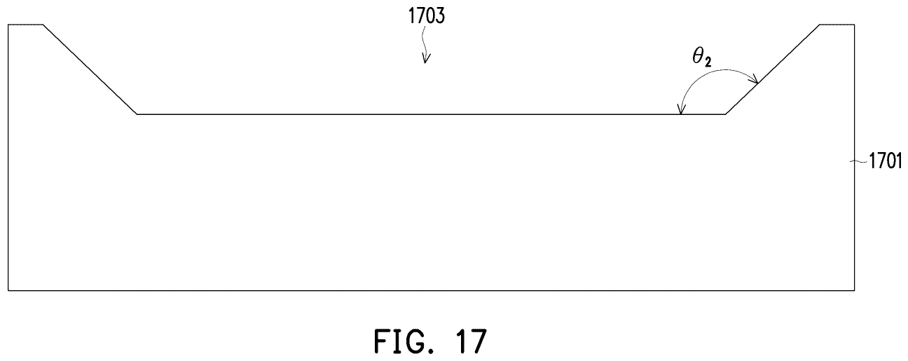

FIG. 17 illustrates another embodiment which utilizes a mirror structure to reflect light signals into and out of an edge coupler of the device. In the embodiments illustrated in FIG. 17, the manufacturing process can begin by initially patterning a third substrate 1701 to form a recess 1703. In an embodiment the third substrate 1701 may be similar to the first substrate 101 (as described above with respect to FIG. 1). For example, the third substrate 1701 may be a silicon substrate. However, any suitable substrate may be utilized.

The third substrate 1701 may be patterned to form the recess 1703. In an embodiment the recess 1703 may be formed using one or more masking and etching processes, such as one or more wet etching processes, one or more dry etching processes, combinations of these, or the like. However, any suitable patterning process may be utilized.

In a particular embodiment the third substrate 1701 is patterned so that sidewalls of the recess 1703 have a second angle θ2 relative to a bottom of the third substrate 1701. The second angle θ2 is utilized to reflect light and, as such, may be between about 45° and abou 55°. However, any suitable angle may be utilized.

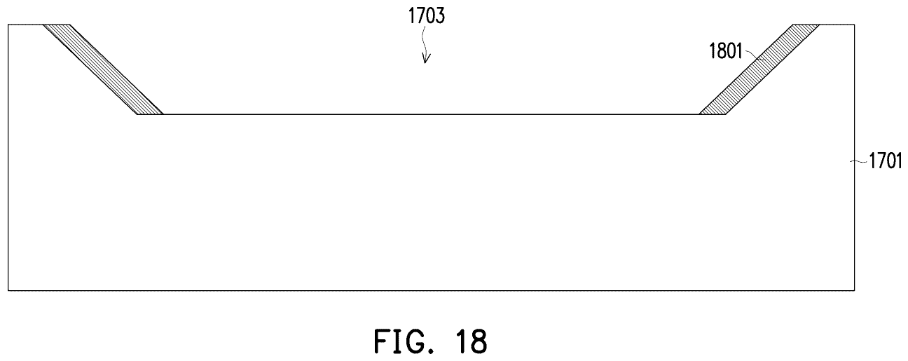

FIG. 18 illustrates a formation of a second mirror coating 1801 along the sidewalls of the recess 1703. In an embodiment the second mirror coating 1801 may be formed using similar methods and materials as the first mirror coating 1101 described above with respect to FIG. 11. For example, the second mirror coating 1801 may be a material such as copper deposited along the sidewalls using, e.g., a masking and plating process. However, any suitable method may be utilized.

Optionally, during the formation of the second mirror coating 1801, contact pads (not separately illustrated in FIG. 18) may also be formed along a bottom of the recess 1703. In some embodiments the contact pads may be formed simultaneously with the second mirror coating 1801, although in other embodiments the contact pads may be made sequentially with, or even in a separate process from, the second mirror coating 1801. Any suitable method may be utilized.

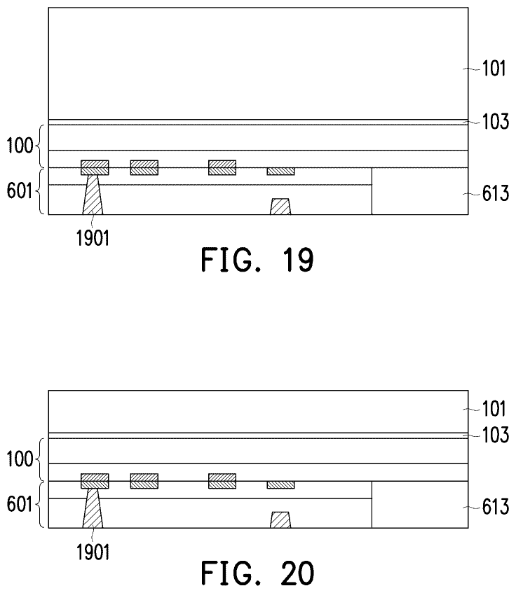

FIG. 19 illustrates the structure of FIG. 6, which illustrates the optical interposer 100 over the first substrate 101 and already bonded to the first semiconductor device 601, with the first gap-fill material 613 already in place. In this embodiment, however, there is a second TSV 1901 extending through the first semiconductor device 601. In an embodiment the second TSV 1901 may be formed using similar materials and similar processes as the first TSVs 901 described above with respect to FIG. 9. However, any suitable methods and materials may be utilized.

FIG. 20 illustrates a thinning of the first substrate 101. In an embodiment the first substrate 101 may be thinned using one or more planarization processes, such as one or more chemical mechanical polishing processes, one or more grinding processes, one or more etching processes, combinations of these, or the like. However, any suitable method may be utilized.

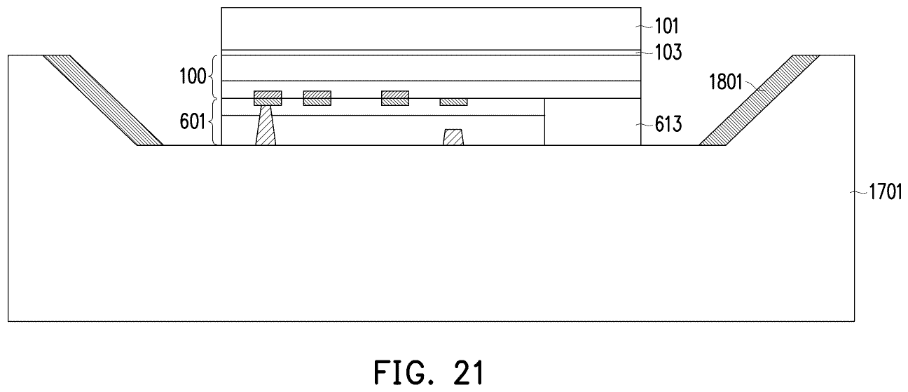

FIG. 21 illustrates a bonding of the first semiconductor device 601 to the third substrate 1701. In an embodiment in which the contact pads are formed within the recess 1703, the first semiconductor device 601 may be bonded using a metal-to-metal and dielectric-to-dielectric bonding process. In other embodiments, for example embodiments in which the contact pads are not formed within the recess 1703, the bonding may be performed using a fusion bonding process. However, any suitable bonding process may be utilized.

Additionally, while FIG. 21 illustrates an embodiment in which the first semiconductor device 601 is bonded to the bottom surface of the recess 1703, this is intended to be illustrative and is not intended to limit the embodiments. For example, in other embodiments the first substrate 101 may be bonded to the third substrate 1701 such that the optical interposer 100 is located between the first semiconductor device 601 and the third substrate 1701. Any suitable arrangement may be utilized.

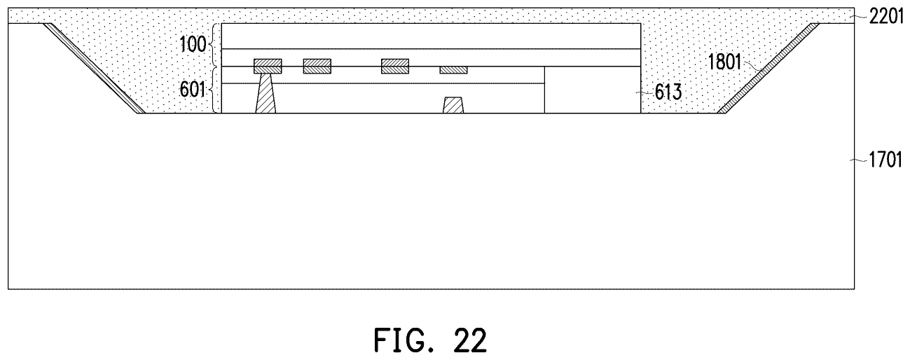

FIG. 22 illustrates a removal of the first substrate 101 and the first insulator layer 103. In an embodiment the first substrate 101 and the first insulator layer 103 may be removed using one or more planarization processes, such as chemical mechanical polishing processes. However, any suitable method may be utilized.

Once the first substrate 101 and the first insulator layer 103 have been removed, a second gap-fill material 2201 may be deposited to fill and/or overfill the recess 1703. In an embodiment the second gap-fill material 2201 may be formed using similar processes and materials as the first gap-fill material 613 described above with respect to FIG. 6. Once the second gap-fill material 2201 has been deposited, the second gap-fill material 2201 may be planarized using, e.g., a chemical mechanical polishing process.

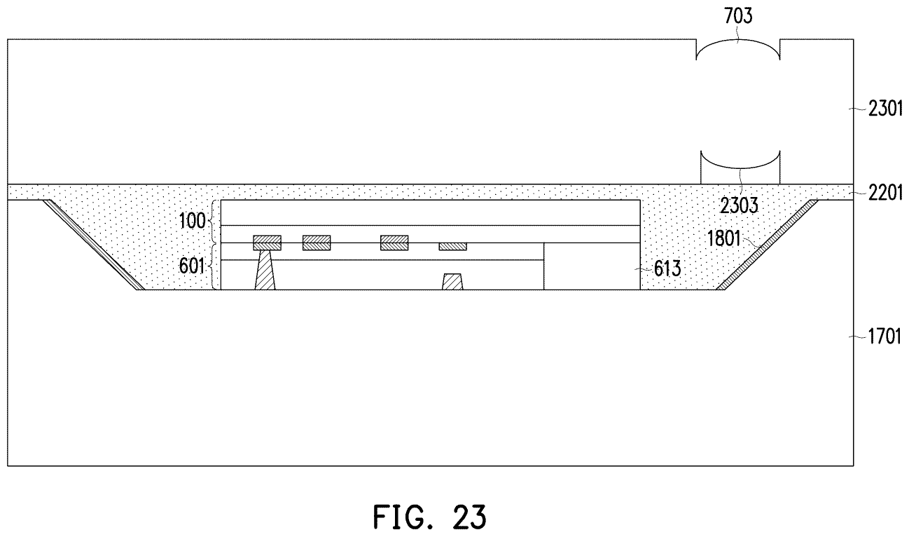

FIG. 23 illustrates an attachment of a second support substrate 2301 onto the third substrate 1701. In an embodiment the second support substrate 2301 may be similar to the first support substrate 701 (described above with respect to FIG. 7), such as by being a silicon material with a first coupling lens 703 formed therein. However, any suitable material may be utilized.

Optionally, if desired, the second support substrate 2301 may include not only the first coupling lens 703, but also a second coupling lens 2303 on an opposite side of the second support substrate 2301 from the first coupling lens 703. In an embodiment the second coupling lens 2303 may be formed using similar processes as the first coupling lens 703, wherein the similar processes are performed on an opposite side of the second support substrate 2301 from the first coupling lens 703. However, any suitable process may be utilized.

In another embodiment which uses both the first coupling lens 703 and the second coupling lens 2303, the first coupling lens 703 may be formed on the second support substrate 2301 while the second coupling lens 2303 is formed on a third support substrate (not separately illustrated in FIG. 23 and which may be similar to the second support substrate 2301). Once the first coupling lens 703 and the second coupling lens 2303 have been formed on the separate substrates, the second support substrate 2301 and the third support substrate may be bonded together before being adhered or bonded to the third substrate 1701.

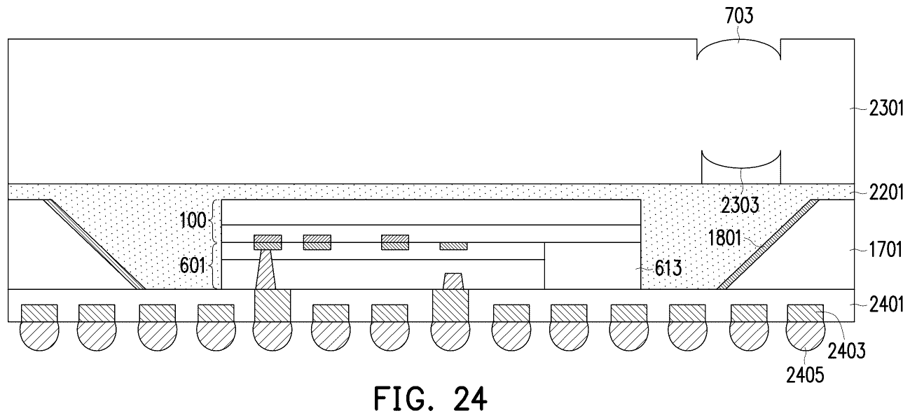

FIG. 24 illustrates a removal of the third substrate 1701 to expose the first semiconductor device 601. In an embodiment the third substrate 1701 may be removed using, e.g., one or more planarization processes, such as a chemical mechanical planarization process. However, any suitable process may be utilized.

FIG. 24 additionally illustrates that, once the second carrier substrate 1701 has been partially removed, a third passivation layer 2401, third contact pads 2403, and second external connectors 2405 may be formed to provide external connectivity. In an embodiment the third passivation layer 2401, the third contact pads 2403, and the second external connectors 2405 may be formed using similar materials and similar processes as the second passivation layer 1501, the second contact pads 1503, and the first external connectors 1505 described above with respect to FIG. 15. However, any suitable methods and materials may be utilized.

In operation, the optical fiber 1602 can supply an optical signal to the first coupling lens 703, which directs the optical signal through the second coupling lens 2303 and the second gap-fill material 2201 and impacts the second mirror coating 1801. The second mirror coating 1801 reflects the optical signal towards the optical interposer 100, where the optical signal is received by an edge coupler. Similarly, the optical interposer 100 can route an optical signal to the second mirror coating 1801, which reflects the transmitted optical signal to the optical fiber 1602.

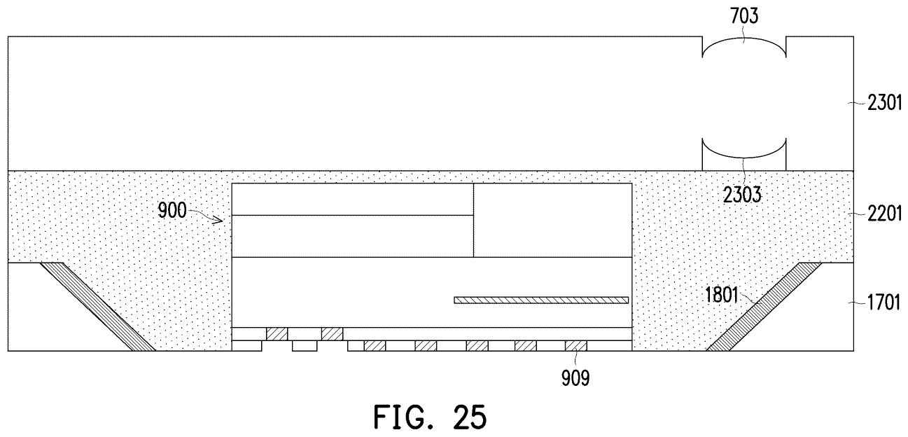

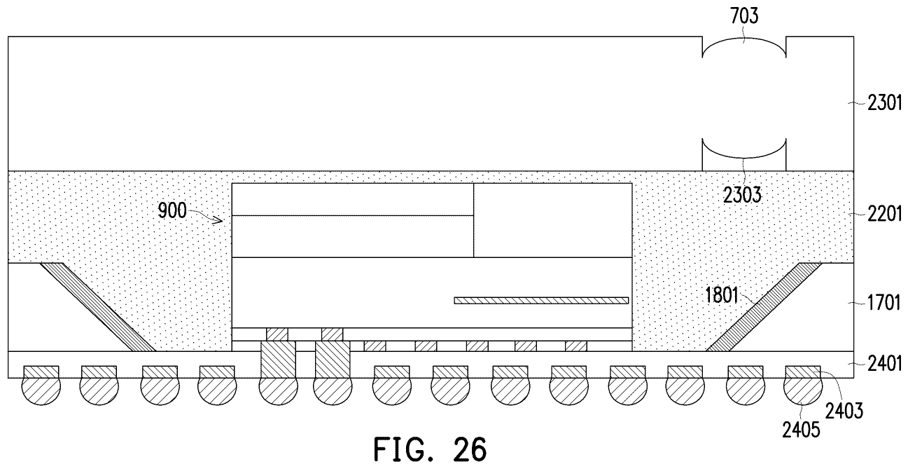

FIGS. 25-26 illustrate another embodiment in which the third substrate 1701 is used, but in which the third bond pads 909 of the first optical package 900 are bonded to the third substrate 1701 (instead of the first semiconductor device 601 as described above with respect to FIG. 21). In this embodiment, because the first semiconductor device 601 is not located between the optical interposer 100 and the third substrate 1701, there is no need for the second TSVs 1901 and these structures may or may not be omitted from the first semiconductor device 601.

In an embodiment the first optical package 900 may be bonded as described above with respect to FIG. 13, such as by using a dielectric-to-dielectric and metal-to-metal bond, although any suitable bonding process may be utilized. Once bonded, the second gap-fill material 2201 may be deposited and the second support substrate 2301 may be attached. Additionally, the third substrate 1701 may be thinned to expose the third bond pads 909.

FIG. 26 illustrates that, once the third bond pads 909 have been exposed, the third passivation layer 2401, the third contact pads 2403, and the second external connectors 2405 may be formed. In an embodiment the third passivation layer 2401, the third contact pads 2403, and the second external connectors 2405 may be formed as described above with respect to FIG. 24. However, any suitable methods and materials may be used to form the third passivation layer 2401, the third contact pads 2403, and the second external connectors 2405.

By bonding the optical engine with the third substrate 1701, additional mechanical strength may be added to the optical engine. Additionally, by using the second mirror coating 1801, an edge coupler can be utilized to make the transfer of signals to and from an optical fiber, avoiding the losses associated with grating couplers. As such, a stronger device with less losses can be incorporated into advanced packages, such as chip-on-wafer-on substrate packages.

In an embodiment, a method of manufacturing an optical device includes: patterning a first substrate to form a recess with a sidewall; forming a mirror coating on the sidewall; depositing and patterning a material to form a first waveguide adjacent to the mirror coating; and bonding an optical interposer over the first waveguide. In an embodiment the method further includes forming a contact pad simultaneously with the mirror coating. In an embodiment the method further includes forming a through via to make physical contact with the contact pad. In an embodiment the method further includes removing a portion of the first substrate to expose the contact pad. In an embodiment the forming the mirror coating forms a distributed Braggs reflector. In an embodiment the forming the mirror coating forms copper. In an embodiment the optical interposer is bonded to an electrical integrated circuit.

In another embodiment, a method of manufacturing an optical device includes: patterning a first substrate to form a first recess; applying a mirror coating along at least sidewalls of the first recess; placing an optical interposer within the first recess, wherein a waveguide within the optical interposer is aligned with the mirror coating; and depositing a gap-fill material around the optical interposer. In an embodiment the method further includes removing a portion of the first substrate to expose the optical interposer. In an embodiment the method further includes thinning a second substrate attached to the optical interposer after the placing the optical interposer. In an embodiment the method further includes attaching a first support substrate to the gap-fill material. In an embodiment the first support substrate comprises a first lens and a second lens different from the first lens. In an embodiment the method further includes bonding the first support substrate to a second support substrate prior to the attaching the first support substrate, wherein the first support substrate comprises a first lens and the second support substrate comprises a second lens different from the first lens. In an embodiment the optical interposer is bonded to an electronic integrated circuit, the electronic integrated circuit comprising a through device via.

In yet another embodiment an optical device includes: an optical interposer; an electrical integrated circuit bonded to the optical interposer; and a mirror structure bonded to the optical interposer, the mirror structure including: a silicon substrate; a mirror coating along a sidewall of the silicon substrate; and an edge coupler adjacent to the mirror coating. In an embodiment the optical device further includes a through via extending through the mirror structure. In an embodiment the mirror structure further comprises an external connector in electrical connection with the through via. In an embodiment the optical device further includes an interposer substrate bonded to the external connector. In an embodiment the optical device further includes an integrated fan-out substrate bonded to the external connector. In an embodiment the integrated fan-out substrate comprises a local silicon interconnect.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. (canceled)

2. An optical device comprising:
a first substrate with a recess, the recess comprising a sidewall;
a mirror coating on the sidewall;
a first waveguide adjacent to the mirror coating; and
an optical interposer bonded over the first waveguide.

3. The optical device of claim 2, further comprising a contact pad in the recess, the contact pad comprising a first material and the mirror coating comprising the first material.

4. The optical device of claim 3, further comprising a through via in physical contact with the contact pad.

5. The optical device of claim 2, wherein the mirror coating is a distributed Bragg reflector.

6. The optical device of claim 2, wherein the mirror coating comprises copper.

7. The optical device of claim 2, further comprising a semiconductor die bonded to the optical interposer.

8. An optical device comprising:
a first recess in a first substrate;
a mirror coating along at least one sidewall of the first recess;
an optical interposer within the first recess, wherein a waveguide within the optical interposer is aligned with the mirror coating; and
a gap-fill material around the optical interposer.

9. The optical device of claim 8, wherein a first surface of the first substrate is planar with a second surface of the optical interposer.

10. The optical device of claim 8, further comprising a support substrate bonded to the gap-fill material.

11. The optical device of claim 10, further comprising a first lens of the support substrate being located directly over the mirror coating.

12. The optical device of claim 8, further comprising a semiconductor device bonded to the optical interposer.

13. The optical device of claim 12, wherein the semiconductor device comprises a through device via.

14. The optical device of claim 8, wherein the mirror coating comprises copper.

15. An optical device comprising:
a mirror coating on a sidewall of a substrate;
first optical components located adjacent to the mirror coating;
a first optical interposer comprising a first layer of second optical components overlying the mirror coating; and
a through via extending from a first side of a recess bounded by the sidewall to a second side of the recess opposite the first side, the through via being electrically connected to the first optical interposer.

16. The optical device of claim 15, wherein the mirror coating comprises copper.

17. The optical device of claim 15, wherein the mirror coating comprises a distributed Bragg reflector.

18. The optical device of claim 15, further comprising a semiconductor die bonded to the first optical interposer.

19. The optical device of claim 15, further comprising an external connector on an opposite side of the substrate from the first optical interposer, the external connector in electrical connection with the through via.

20. The optical device of claim 19, further comprising an interposer substrate bonded to the external connector.

21. The optical device of claim 19, further comprising an integrated fan-out substrate bonded to the external connector.
